(19) United States
(12) Patent Application Publication
(10) Pub. No.: US 2025/0208298 A1
(43) Pub. Date: Jun. 26, 2025

(54) DISTANCE IMAGE CAPTURING DEVICE AND DISTANCE IMAGE CAPTURING METHOD

(71) Applicant: TOPPAN Holdings Inc., Tokyo (JP)

(72) Inventor: Tetsuya IIDA, Tokyo (JP)

(73) Assignee: TOPPAN Holdings Inc., Tokyo (JP)

(21) Appl. No.: 18/986,081

(22) Filed: Dec. 18, 2024

(30) Foreign Application Priority Data
Dec. 22, 2023 (JP) 2023-216662

(51) Int. Cl. G01S 17/894; G01S 7/481; G01S 7/4865

(52) U.S. Cl. CPC G01S 17/894; G01S 7/4814; G01S 7/4816; G01S 7/4865

(57) ABSTRACT

A distance image capturing device executes a driving for a unit accumulation period the number of accumulation times, executes an accumulation phase, and a discharge phase, and executes an adjustment phase at a timing at which the discharge phase for the previously executed unit accumulation period is switched to the unit accumulation period to be executed this time is executed, and sequentially executes a first driving in which the charge discharge unit is caused not to discharge the charge and the charge is not accumulated in the charge accumulation unit, and a second driving in which the charge is discharged through the charge discharge unit in the adjustment phase, in which a time for executing the second driving is the same as an accumulation driving time for executing an accumulation driving in which the charge is accumulated in one charge accumulation unit in the accumulation phase.

### BACKGROUND OF THE INVENTION

### Field of the Invention

The present disclosure relates to a distance image capturing device and a distance image capturing method.

Priority is claimed on Japanese Patent Application No. 2023-216662, filed on Dec. 22, 2023, the content of which is incorporated herein by reference.

### Description of Related Art

A time of flight (hereinafter, referred to as “TOF”) type distance image capturing device has been implemented that uses a known speed of light and measures a distance between a measuring instrument and an object based on a flight time of light in space (measurement space) (for example, refer to Japanese Patent No. 4235729).

A photoelectric conversion unit, a plurality of charge accumulation units, a charge discharge unit, and the like is provided in an imaging element (pixel) of such a distance image capturing device. The driving of the pixel by one frame cycle is executed by repeatedly executing the driving for a unit accumulation period in which the pulse light is irradiated onto a subject and the reflected light reflected on a measurement object (subject) is incident on the pixel for the number of accumulation times. In the driving for the unit accumulation period, an accumulation phase of accumulating a charge and a discharge phase of discharging the charge are executed.

### SUMMARY OF THE INVENTION

However, even when the same amount of light is incident, there may be a difference in the amount of charges accumulated between a first charge accumulation unit which first accumulates the charge, and the other charge accumulation units which accumulate the charge second or subsequent times, in the accumulation phase, which is a factor that deteriorates the accuracy of the distance.

One of the factors that cause a difference in the amount of charges accumulated in the first charge accumulation unit and the other charge accumulation units is a difference in driving conditions. In the driving for the unit accumulation period, the time for executing the accumulation phase is often set to be relatively short, and the time for executing the discharge phase is often set to be relatively long. Therefore, the first charge accumulation unit starts the accumulation of the charge at a timing at which a state where the charge is discharged through the charge discharge unit in the discharge phase for the previous unit accumulation period continues for a long time and then is switched to a state where the charge is not discharged. On the other hand, in the other charge accumulation units, the accumulation of the charge is started at a timing at which the short-time charge accumulation in the charge accumulation unit in a previous stage is completed. It is considered that such a difference in driving conditions is one of factors that deteriorate the accuracy of the distance.

The present disclosure has been made in view of the above-described problems, and an object thereof is to provide a distance image capturing device and a distance image capturing method capable of driving a pixel such that driving conditions of a first charge accumulation unit, which first accumulates the charge, and the other charge accumulation units which accumulate the charge second or subsequent times, among a plurality of charge accumulation units, are close to each other.

A distance image capturing device according to the present disclosure includes a light source unit configured to irradiate a subject with an optical pulse, a light receiving unit including a distance image sensor in which a plurality of pixels having a photoelectric conversion element configured to generate a charge in accordance with incident light, a charge discharge unit configured to discharge the charge generated by the photoelectric conversion element, and a plurality of charge accumulation units configured to accumulate the charge generated by the photoelectric conversion element are arranged in a two-dimensional matrix shape, and a pixel drive circuit configured to distribute and accumulate the charge to each of the charge accumulation units at an accumulation timing synchronized with an irradiation timing at which the optical pulse is emitted according to a frame cycle, and a distance image processing unit configured to calculate a distance to the subject based on an amount of charges accumulated in each of the charge accumulation units, in which a driving for a unit accumulation period is executed the number of accumulation times in the frame cycle, in the unit accumulation period, an accumulation phase in which the charge is sequentially accumulated in the charge accumulation unit at the accumulation timing, and a discharge phase in which the charge is discharged through the charge discharge unit are executed, and an adjustment phase is executed at a timing at which the discharge phase for a previously executed unit accumulation period is switched to the unit accumulation period to be executed this time, in the adjustment phase, a first driving in which the charge discharge unit is caused not to discharge the charge and the charge is not accumulated in the charge accumulation unit, and a second driving in which the charge is discharged through the charge discharge unit are sequentially executed, and a time for executing the second driving is the same as an accumulation driving time for executing an accumulation driving in which the charge is accumulated in one charge accumulation unit in the accumulation phase.

A distance image capturing method according to the present disclosure performed by a distance image capturing device including a light source unit configured to irradiate a subject with an optical pulse, a light receiving unit including a distance image sensor in which a plurality of pixels having a photoelectric conversion element configured to generate a charge in accordance with incident light, a charge discharge unit configured to discharge the charge generated by the photoelectric conversion element, and a plurality of charge accumulation units configured to accumulate the charge generated by the photoelectric conversion element are arranged in a two-dimensional matrix shape, and a pixel drive circuit configured to distribute and accumulate the charge to each of the charge accumulation units at an accumulation timing synchronized with an irradiation timing at which the optical pulse is emitted according to a frame cycle, and a distance image processing unit configured to calculate a distance to the subject based on an amount of charges accumulated in each of the charge accumulation units, the method including executing a driving for a unit accumulation period the number of accumulation times in the frame cycle, executing, in the unit accumulation period, an accumulation phase in which the charge is sequentially accumulated in the charge accumulation unit at the accumulation timing, and a discharge phase in which the charge is discharged through the charge discharge unit, and executing an adjustment phase at a timing at which the discharge phase for a previously executed unit accumulation period is switched to the unit accumulation period to be executed this time, and sequentially executing, in the accumulation phase, a first driving in which the charge discharge unit is caused not to discharge the charge and the charge is not accumulated in the charge accumulation unit, and a second driving in which the charge is discharged through the charge discharge unit in the adjustment phase, in which a time for executing the second driving is the same as an accumulation driving time for executing an accumulation driving in which the charge is accumulated in one charge accumulation unit.

According to the present disclosure, the pixel can be driven such that the driving conditions of the first charge accumulation unit which first accumulates the charge, and the other charge accumulation units which accumulate the charge second or subsequent times, among the plurality of charge accumulation units, are close to each other.

### BRIEF DESCRIPTION OF THE DRAWINGS

FIG. 1 is a block diagram showing a configuration of a distance image capturing device 1 according to an embodiment.

FIG. 2 is a block diagram showing a configuration of a distance image sensor 32 according to the embodiment.

FIG. 3 is a circuit diagram showing an example of a configuration of a pixel 321 according to the embodiment.

FIG. 4A is a diagram schematically showing an example of a layout pattern of the pixel 321 according to the embodiment.

FIG. 4B is a timing chart showing a timing at which the pixel 321 in the related art is driven.

FIG. 4C is a diagram showing an image of pixel signals Q1 to Q4 driven in FIG. 4B.

FIG. 5 is a timing chart showing a first example of a timing at which the pixel 321 according to the embodiment is driven.

FIG. 6 is a timing chart showing a second example of a timing at which the pixel 321 according to the embodiment is driven.

FIG. 7 is a timing chart showing a third example of a timing at which the pixel 321 according to the embodiment is driven.

FIG. 8A is a diagram schematically showing an example of a layout pattern of the pixel 321 according to the embodiment.

FIG. 8B is a diagram schematically showing an example of a layout pattern of the pixel 321 according to the embodiment.

FIG. 8C is a diagram schematically showing an example of a layout pattern of the pixel 321 according to the embodiment.

FIG. 9 is a timing chart showing a fourth example of a timing at which the pixel 321 according to the embodiment is driven.

FIG. 10 is a timing chart showing a fifth example of a timing at which the pixel 321 according to the embodiment is driven.

FIG. 11 is a timing chart showing a sixth example of a timing at which the pixel 321 according to the embodiment is driven.

FIG. 12 is a timing chart showing a seventh example of a timing at which the pixel 321 according to the embodiment is driven.

FIG. 13 is a timing chart showing an eighth example of a timing at which the pixel 321 according to the embodiment is driven.

### DETAILED DESCRIPTION OF THE INVENTION

Hereinafter, a distance image capturing device according to the embodiment will be described with reference to the drawings.

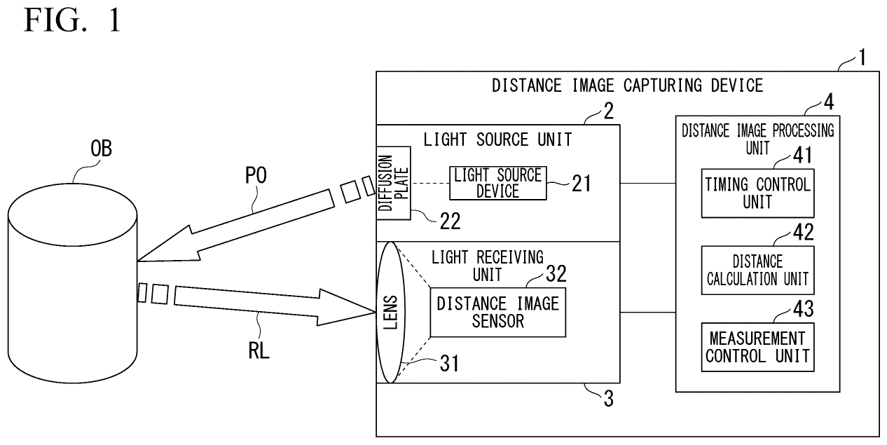

FIG. 1 is a block diagram showing a schematic configuration of a distance image capturing device according to the embodiment. For example, a light source unit 2, a light receiving unit 3, and a distance image processing unit 4 is provided in the distance image capturing device 1. FIG. 1 also shows a subject OB, which is an object for measuring a distance in the distance image capturing device 1.

The light source unit 2 emits an optical pulse PO to the subject OB under the control of the distance image processing unit 4. For example, the light source unit 2 is a surface emitting semiconductor laser module such as a vertical cavity surface emitting laser (VCSEL). The light source unit 2 includes a light source device 21 and a diffusion plate 22.

The light source device 21 is a light source that emits laser light in a near-infrared wavelength band (for example, a wavelength band with a wavelength of 850 nm to 940 nm) as the optical pulse PO which is emitted to the subject OB. For example, the light source device 21 is a semiconductor laser light emitting element. The light source device 21 emits pulsed laser light in accordance with the control of a timing control unit 41.

The diffusion plate 22 is an optical component that diffuses the laser light in the near-infrared wavelength band emitted by the light source device 21 to a size of a surface for emitting to the subject OB. The pulsed laser light diffused by the diffusion plate 22 is emitted as the optical pulse PO, and emitted to the subject OB.

The light receiving unit 3 receives reflected light RL of the optical pulse PO reflected by the subject OB and outputs a pixel signal corresponding to the received reflected light RL. The light receiving unit 3 includes a lens 31 and a distance image sensor 32.

The lens 31 is an optical lens that guides the incident reflected light RL to the distance image sensor 32. The lens 31 emits the incident reflected light RL to the distance image sensor 32 side, and causes the reflected light RL to be received by (incident on) pixels provided in the light receiving region of the distance image sensor 32.

The distance image sensor 32 is an imaging element. The distance image sensor 32 includes a plurality of pixels arranged in a two-dimensional matrix shape. In each of the pixels of the distance image sensor 32, one photoelectric conversion element, a plurality of charge accumulation units corresponding to the one photoelectric conversion element, and a component that distributes the charges to each of the charge accumulation units are provided. That is, the pixel is the imaging element having a distribution configuration in which the charges are distributed and accumulated in the plurality of charge accumulation units.

The distance image sensor 32 distributes the charges generated by the photoelectric conversion element to each of the charge accumulation units, in accordance with control from the timing control unit 41. In addition, the distance image sensor 32 outputs a pixel signal corresponding to the amount of charges distributed to the charge accumulation units. In the distance image sensor 32, a plurality of pixels are arranged in a two-dimensional matrix, and a pixel signal for one frame corresponding to each of the pixels is output.

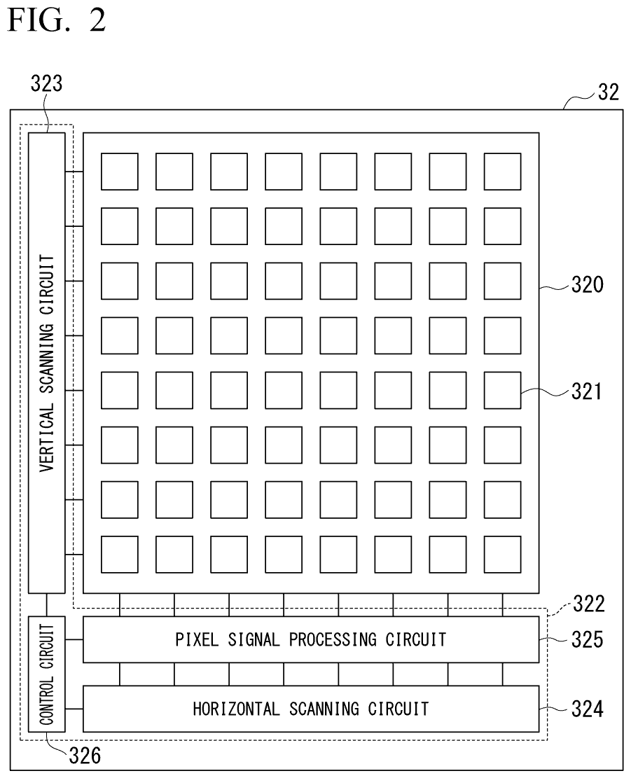

Here, the configuration of the distance image sensor 32 will be described with reference to FIG. 2. FIG. 2 is a block diagram showing a schematic configuration of the imaging element (distance image sensor 32) used in the distance image capturing device 1 according to the embodiment.

As shown in FIG. 2, for example, the distance image sensor 32 includes a light receiving region 320 in which a plurality of pixels 321 are arranged in a two-dimensional matrix shape, and a pixel drive circuit 322. For example, the pixel drive circuit 322 includes a vertical scan circuit 323 having a distribution operation, a horizontal scan circuit 324, a pixel signal processing circuit 325, and a control circuit 326.

The light receiving region 320 is a region in which the plurality of pixels 321 are arranged in a two-dimensional matrix shape, and FIG. 2 shows an example in which the plurality of pixels 321 are arranged in a two-dimensional matrix shape of eight rows and eight columns. The pixel 321 accumulates the charge corresponding to the received amount of light and outputs an accumulation signal corresponding to the accumulated amount of charges.

The control circuit 326 collectively controls the distance image sensor 32. For example, the control circuit 326 controls operations of components of the distance image sensor 32 in response to an instruction from the timing control unit 41 of the distance image processing unit 4. The components provided in the distance image sensor 32 may be controlled directly by the timing control unit 41, and in this case, the control circuit 326 can also be omitted.

The vertical scan circuit 323 controls the pixels 321 arranged in the light receiving region 320 for each row under the control of the control circuit 326. The vertical scan circuit 323 outputs a voltage signal according to the amount of charges accumulated in each of the charge accumulation units CS of the pixel 321 to the pixel signal processing circuit 325. For example, the vertical scan circuit 323 distributes the charges converted by a photoelectric conversion element to each of the charge accumulation units of the pixel 321 at an accumulation timing synchronized with the irradiation of the optical pulse PO and accumulates therein. In addition, the vertical scan circuit 323 discharges the charge converted by the photoelectric conversion element from a charge discharge unit (a charge discharge transistor GD to be described below) in a period (for example, a readout period) different from an accumulation period in which the charge is accumulated in the charge accumulation unit CS.

The pixel signal processing circuit 325 performs predetermined signal processing (for example, noise suppression processing, A/D conversion processing, or the like) for a voltage signal output to a corresponding vertical signal line from the pixels 321 in each of the columns under the control of the control circuit 326.

The horizontal scan circuit 324 sequentially outputs signals output from the pixel signal processing circuit 325 in time series under the control of the control circuit 326. As a result, an accumulation signal in one frame is sequentially output to the distance image processing unit 4. Hereinafter, it is assumed that the pixel signal processing circuit 325 performs A/D conversion processing and the accumulation signal is a digital signal.

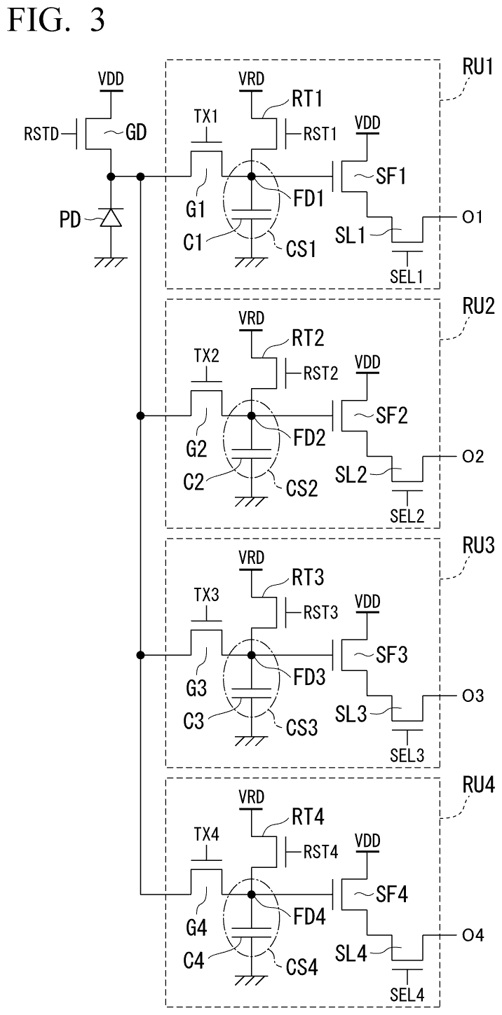

Here, the configuration of the pixel 321 will be described with reference to FIG. 3. FIG. 3 is a circuit diagram showing an example of the pixel 321. FIG. 3 shows an example of the configuration of one pixel 321 among the plurality of pixels 321 arranged in the light receiving region 320. In this figure, an example in which the pixel 321 includes four signal readout units RU (signal readout units RU1 to RU4) is shown.

The pixel 321 includes one photoelectric conversion element PD, a charge discharge transistor GD, and four signal readout units RU that output a voltage signal from a corresponding output terminal O. Each of the signal readout units RU includes a transfer transistor G, a floating diffusion FD, a charge accumulation capacitor C, a reset transistor RT, a source follower transistor SF, and a select transistor SL. The charge accumulation unit CS includes the floating diffusion FD and the charge accumulation capacitor C.

In FIG. 3, each of the signal readout units RU is distinguished by assigning any one number of “1” to “4” after the reference numeral “RU” of the four signal readout units RU. In addition, similarly, each of the components included in the four signal readout units RU is also represented by distinguishing the signal readout units RU corresponding to each of the components by indicating the number representing each signal readout unit RU after the reference numeral.

In FIG. 3, each of the signal readout units RU is distinguished by assigning any one number of “1” to “4” after the reference numeral “RU” of the four signal readout units RU. In addition, similarly, each of the components included in the four signal readout units RU is also represented by distinguishing the signal readout units RU corresponding to each of the components by indicating the number representing each signal readout unit RU after the reference numeral.

In the pixel 321, the signal readout unit RU1 outputs a voltage signal from an output terminal O1. The signal readout unit RU1 includes a transfer transistor G1, a floating diffusion FD1, a charge accumulation capacitor C1, a reset transistor RT1, a source follower transistor SF1, and a select transistor SL1. The charge accumulation unit CS1 is configured with the floating diffusion FD1 and the charge accumulation capacitor C1. Signal readout units RU2 to RU4 also have the same configuration.

The photoelectric conversion element PD is an embedded photodiode that photoelectrically converts incident light to generate the charge according to the intensity of the incident light and accumulates the generated charge. The photoelectric conversion element PD may have any structure. For example, the photoelectric conversion element PD may be a PN photodiode having a structure in which a P-type semiconductor and an N-type semiconductor are bonded together, or a PIN photodiode having a structure in which an I-type semiconductor is interposed between a P-type semiconductor and an N-type semiconductor. In addition, the photoelectric conversion element PD is not limited to the photodiode, and may be, for example, a photogate type photoelectric conversion element.

The charge discharge transistor GD is a transistor for discarding the charge generated in the photoelectric conversion element PD. When the charge discharge transistor GD is controlled to be in an on-state by the pixel drive circuit 322, the charge discharge transistor GD discards the charge generated in the photoelectric conversion element PD (that is, resets the photoelectric conversion element PD).

The pixel drive circuit 322 drives the pixel 321, distributes the charges generated by photoelectrically converting incident light by using the photoelectric conversion element PD to each of the four charge accumulation units CS, and outputs each of voltage signals corresponding to the amount of charges of the distributed charges to the pixel signal processing circuit 325.

For example, in driving the pixel 321, the pixel drive circuit 322 controls accumulation drive signals TX1 to TX4 corresponding to each of the charge accumulation units CS1 to CS4 to be sequentially in an on-state in synchronization with an irradiation timing of the optical pulse PO. Accordingly, the transfer transistors G1 to G4 corresponding to each of the charge accumulation units CS are sequentially turned on, and the charges are distributed and accumulated in the corresponding charge accumulation units CS. As a result, the charges are sequentially accumulated in the charge accumulation units CS1, CS2, CS3, and CS4.

The pixel 321 is not limited to the configuration including four signal readout units RU as shown in FIG. 3, and may have a configuration including a plurality of signal readout units RU. That is, the number of signal readout units RU (charge accumulation units CS) included in the pixels arranged in the distance image sensor 32 may be two, three, or five or more.

In addition, FIG. 3 shows an example in which the charge accumulation unit CS is configured by the floating diffusion FD and the charge accumulation capacitor C. However, the charge accumulation unit CS may include at least the floating diffusion FD, and the pixel 321 may not include the charge accumulation capacitor C.

Returning to the description of FIG. 1, the distance image processing unit 4 controls the distance image capturing device 1 to calculate the distance to the subject OB. The distance image processing unit 4 includes the timing control unit 41, a distance calculation unit 42, and a measurement control unit 43.

The timing control unit 41 controls the timing of outputting various control signals required for measurement in accordance with the control of the measurement control unit 43. For example, the various control signals here are a signal for controlling whether or not to emit the optical pulse PO, a signal for controlling whether or not to accumulate the charge in the charge accumulation unit, a signal for setting the number of accumulation times per frame, and the like. The number of accumulation times is the number of times that processing of distributing and accumulating the charges in the charge accumulation unit CS is repeated, and corresponds to the number of times of distribution set in advance in the frame cycle. The product of the number of accumulation times and the time (accumulation time) for accumulating the charge in each of the charge accumulation units per processing of distributing and accumulating the charges is an exposure time.

The distance calculation unit 42 outputs distance information obtained by calculating the distance to the subject OB based on the pixel signal output from the distance image sensor 32. The distance calculation unit 42 calculates a delay time from when the optical pulse PO is emitted to when the reflected light RL is received, based on the amount of charges accumulated in a plurality of charge accumulation units CS. The distance calculation unit 42 calculates the distance to the subject OB in accordance with the calculated delay time.

The measurement control unit 43 controls the timing control unit 41. For example, the measurement control unit 43 sets the number of accumulation times and an accumulation time width of one frame, and controls the timing control unit 41 such that imaging is performed with the set content. That is, the measurement control unit 43 sets the frame cycle and controls the timing control unit 41 such that the imaging is performed with the set content.

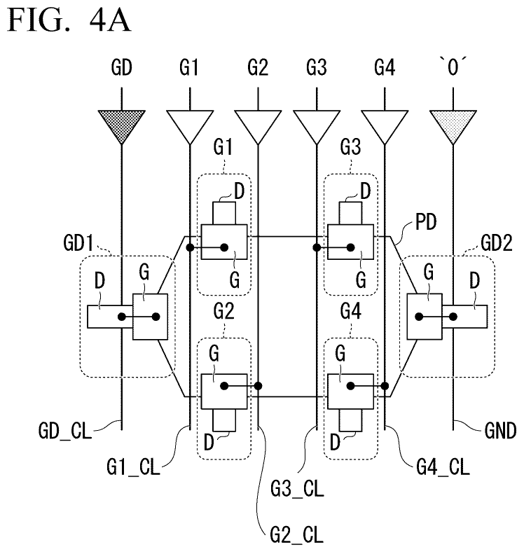

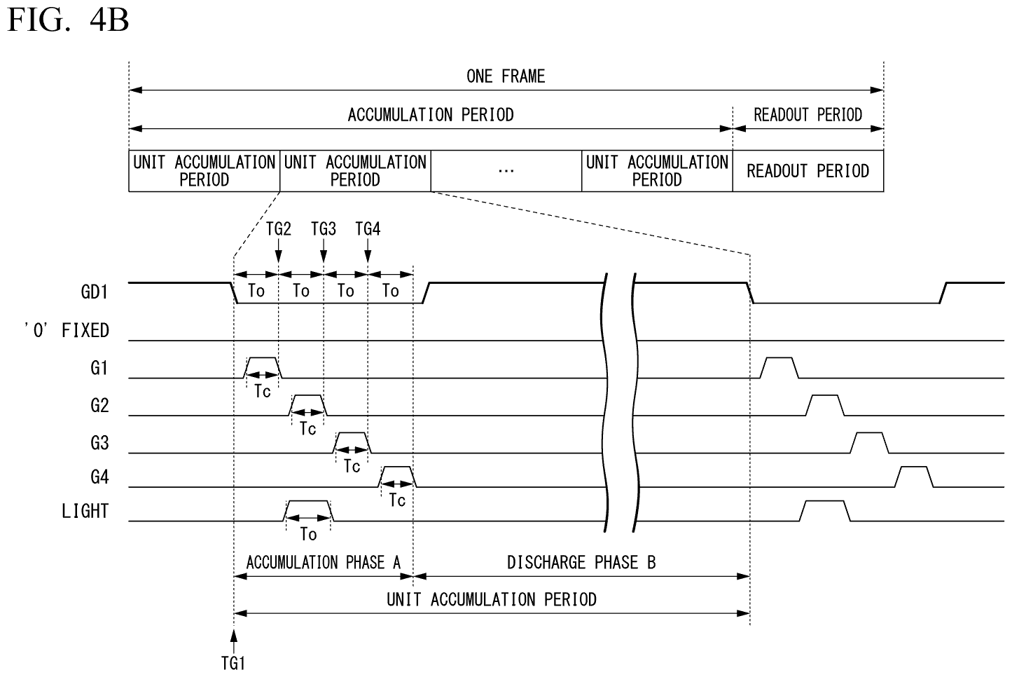

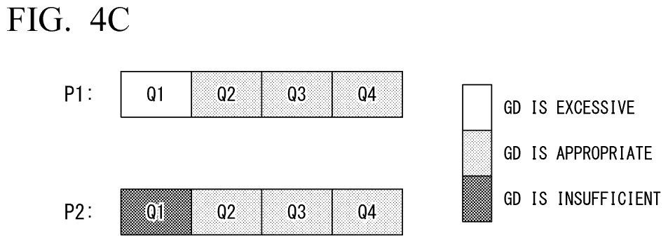

Here, the problems of the present embodiment will be described with reference to FIG. 4 (FIGS. 4A to 4C).

FIG. 4A schematically shows a layout pattern of the pixel 321. As shown in FIG. 4A, the pixel 321 is an integrated circuit in which a transistor, a transfer transistor G (transfer transistors G1 to G4), and a charge discharge transistor GD (charge discharge transistors GD1 and GD2) are mounted on the photoelectric conversion element PD. For example, the transistor is an n-channel type MOS transistor formed on a p-type semiconductor substrate, and includes each of a drain D (n diffusion layer (diffusion layer of n-type impurity)), a source (n diffusion layer), and a gate G.

In the example of FIG. 4A, the description of the transistors other than the transfer transistors G and the charge discharge transistors GD, specifically, the transistors such as the charge discharge transistors GD, the source follower transistors SF1 to SF4, the selection transistors SL1 to SL4, and the reset transistors RT1 to RT4 will be omitted.

The photoelectric conversion element PD is formed in a shape of a long hexagon in which two opposing sides of a long hexagon are longer than the other four sides.

The transfer transistors G1 and G3 are arranged to be symmetrical with respect to an axis passing through the center of the long hexagon and orthogonal to the two long sides of the long hexagon on one side of the two long sides of the long hexagon of the photoelectric conversion element PD. The transfer transistors G2 and G4 are disposed to be symmetrical with respect to an axis passing through the center of the long hexagon and orthogonal to the two long sides of the long hexagon on a side different from a side on which the transfer transistors G1 and G3 are disposed of two long sides of the long hexagon of the photoelectric conversion element PD. The transfer transistors G1 and G2 are disposed to be symmetrical with respect to an axis passing through the center of the long hexagon and parallel to two long sides of the long hexagon. The transfer transistors G3 and G4 are disposed to be symmetrical with respect to an axis passing through the center of the long hexagon and parallel to two long sides of the long hexagon.

The charge discharge transistors GD1 and GD2 are disposed to be symmetrical with respect to an axis passing through the center of the long hexagon and orthogonal to two long sides of the long hexagon at positions of vertices where two adjacent sides of four short sides of the long hexagon of the photoelectric conversion element PD are connected.

In the example of this figure, the gate G of the charge discharge transistor GD1 is connected to a control signal GD_CL for controlling the discharge of the charge. When the control signal GD_CL is High (1), the charge is discharged, and when the control signal GD_CL is Low (0 (zero)), the charge is not discharged.

In addition, the gate G of the charge discharge transistor GD2 is fixed to a fixed value (0 (zero)). Therefore, in the charge discharge transistor GD2, the charge is not discharged at all times.

In addition, the gates G of each of the transfer transistors G1 to G4 are connected to control signals G1_CL to G4_CL for controlling the charge accumulation in the charge accumulation units CS1 to CS4 as the drains D corresponding to each of the transfer transistors G1 to G4. When the control signal Gk_CL is High (1), the charge is accumulated, and when the control signal Gk_CL is Low (0 (zero)), the charge is not accumulated. Here, k is any one of 1 to 4.

FIG. 4B is a timing chart showing a driving example of the pixel 321 in the related art. The driving of the pixel is performed according to a frame cycle, and an accumulation period and a readout period are provided in one frame as shown in FIG. 4B. The accumulation period is a period in which the charge accumulation unit CS accumulates the charge, and is a period in which the driving of the pixel 321 shown in the unit accumulation period is repeated a predetermined number of accumulation times.

The readout period is a period in which the pixel signal Q corresponding to the amount of charges accumulated in each of the charge accumulation units CS is read out.

FIG. 4B shows a timing chart of elements corresponding to each of the items of “GD”, “0 fixed”, “G1” to “G4”, and “LIGHT”. The term “GD” shows an operation timing of the control signal GD_CL for controlling the charge discharge transistor GD1. The term “fixed” shows that the charge discharge transistor GD2 is fixed to Low (fixed to 0 (zero)). The terms “G1” to “G4” show operation timings of control signals G1_CL to G4 CL for controlling the transfer transistors G1 to G4. The term “LIGHT” shows an irradiation timing of the optical pulse PO. Specifically, it is shown that the light is irradiated in the on state (a state where the timing signal is set to High (1)), and the light is turned off in the off state (a state where the timing signal is set to Low (0 (zero))).

As shown in FIG. 4B, the unit accumulation period includes an accumulation phase A and a discharge phase B.

In the accumulation phase A, first, the charge discharge transistor GD is controlled to be in an off state, and then the transfer transistor G1 is controlled to be in an on state. When the accumulation time (for example, an accumulation time To set in accordance with an irradiation time of the optical pulse PO) elapses after the charge discharge transistor GD is controlled to be in an off state, the transfer transistor G1 is controlled to be in an off state.

Here, a period in which the transfer transistor G1 is controlled to be in an on state is an accumulation driving time Tc. The accumulation driving time Tc is set to be shorter than the accumulation time To. In a non-accumulation driving period (=To−Tc) in which the transfer transistor G1 is controlled to be in an off state in the accumulation time To, the charge converted by the photoelectric conversion element PD is accumulated in the photoelectric conversion element PD (not in the charge accumulation unit CS1). By controlling the transfer transistor G1 to be in an on state, the charge accumulated in the photoelectric conversion element PD in the non-accumulation driving period is moved from the photoelectric conversion element PD to the floating diffusion FD1 and is accumulated in the charge accumulation unit CS1. In addition, the charge converted by the photoelectric conversion element PD in the accumulation driving time Tc in which the transfer transistor G1 is controlled to be in an on state is accumulated in the charge accumulation unit CS1. That is, the transfer transistor G1 is controlled to be in an on state in the accumulation driving time Tc, and the charge converted by the photoelectric conversion element PD is accumulated in the charge accumulation unit CS1 in the accumulation time To.

The optical pulse PO is emitted for the irradiation time To at a timing at which the transfer transistor G1 is controlled to be in the off-state. In addition, the transfer transistor G1 is controlled to be in an off state, and then the transfer transistor G2 is controlled to be in an on state. When the accumulation time To elapses after the transfer transistor G1 is controlled to be in an off state, the transfer transistor G2 is controlled to be in an off state. A period in which the transfer transistors G2 are controlled to be in an on state is the accumulation driving time Tc.

The transfer transistor G2 is controlled to be in an off state, and then the transfer transistor G3 is controlled to be in an on state. When the accumulation time To elapses after the transfer transistor G2 is controlled to be in an off state, the transfer transistor G3 is controlled to be in an off state. A period in which the transfer transistor G3 is controlled to be in an on state is the accumulation driving time Tc.

The transfer transistor G3 is controlled to be in an off state, and then the transfer transistor G4 is controlled to be in an on state. When the accumulation time To elapses after the transfer transistor G3 is controlled to be in an off state, the transfer transistor G4 is controlled to be in an off state. A period in which the transfer transistor G4 is controlled to be in an on state is the accumulation driving time Tc. Thereafter, the charge discharge transistor GD is controlled to be in an on state.

In the discharge phase B, the charge discharge transistor GD is maintained in the on state and the transfer transistors G1 to G4 are maintained in the off state until the next unit accumulation period is started.

FIG. 4C is a schematic diagram showing the magnitude of the signal values of the pixel signals Q1 to Q4 corresponding to the amount of charges accumulated in each of the charge accumulation units CS1 to CS4 in a case where the driving shown in FIG. 4B is performed. FIG. 4C shows an example of patterns P1 and P2. In the pattern P1, the signal value of the pixel signal Q1 has an excessive charge discharge (GD) as compared with the other pixel signals Q2 to Q4, and the pixel signal Q1 indicates a value smaller than the other pixel signals. In the pattern P2, the signal value of the pixel signal Q1 has an insufficient charge discharge (GD) as compared with the other pixel signals Q2 to Q4, and the pixel signal Q1 indicates a value larger than the other pixel signals. It is assumed that the amount of light incident on the pixel 321 does not change (is constant) at the timing at which each of the charge accumulation units CS1 to CS4 accumulates the charge.

As described above, a difference tends to occur in the amount of charges accumulated in the pixel signal Q1 and the other pixel signals Q2 to Q4. One of the factors is a difference in driving conditions. As shown in FIG. 4B, in the driving for the unit accumulation period, the pixel 321 is driven such that the accumulation phase A is performed for a relatively short time and the discharge phase B is performed for a relatively long time in many cases. Therefore, the charge accumulation unit CS1 starts the accumulation of the charge at a timing at which a state where the charge is discharged continues for a long time in the discharge phase B for the previous unit accumulation period and then is switched to a state where the charge is not discharged. On the other hand, in the other charge accumulation units, the accumulation of the charge is started at a timing at which the short-time charge accumulation in the charge accumulation unit CS in a previous stage is completed. Specifically, the charge accumulation unit CS2 starts the accumulation of the charge at a timing at which the short-time charge accumulation in the charge accumulation unit CS1 in the previous stage is completed. The charge accumulation unit CS3 starts the accumulation of the charge at a timing at which the short-time charge accumulation in the charge accumulation unit CS2 in the previous stage is completed. The charge accumulation unit CS4 starts the accumulation of the charge at a timing at which the short-time charge accumulation in the charge accumulation unit CS3 in the previous stage is completed. Such a difference in the driving conditions is one of the factors that deteriorate the accuracy of the distance.

As a countermeasure for this, in the present embodiment, the pixels are driven such that the driving conditions of the charge accumulation unit CSI which first accumulates the charge, and the other charge accumulation units CS2 to CS4 which accumulate the charge second or subsequent times, among the plurality of charge accumulation units CS1 to CS4, are close to each other.

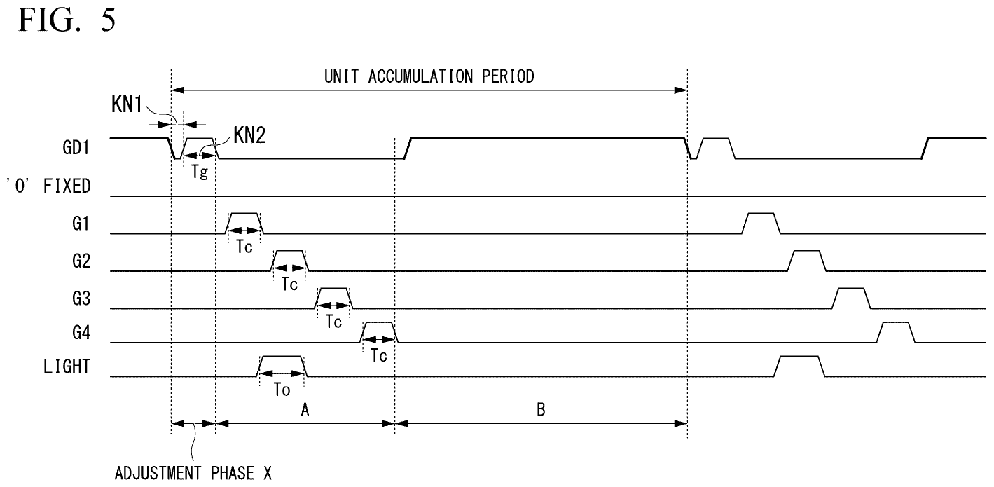

Hereinafter, a method of driving the pixel 321 of the present embodiment will be described with reference to FIGS. 5 to 13. FIGS. 5 to 7 are timing charts showing driving examples of the pixel 321 according to the embodiment.

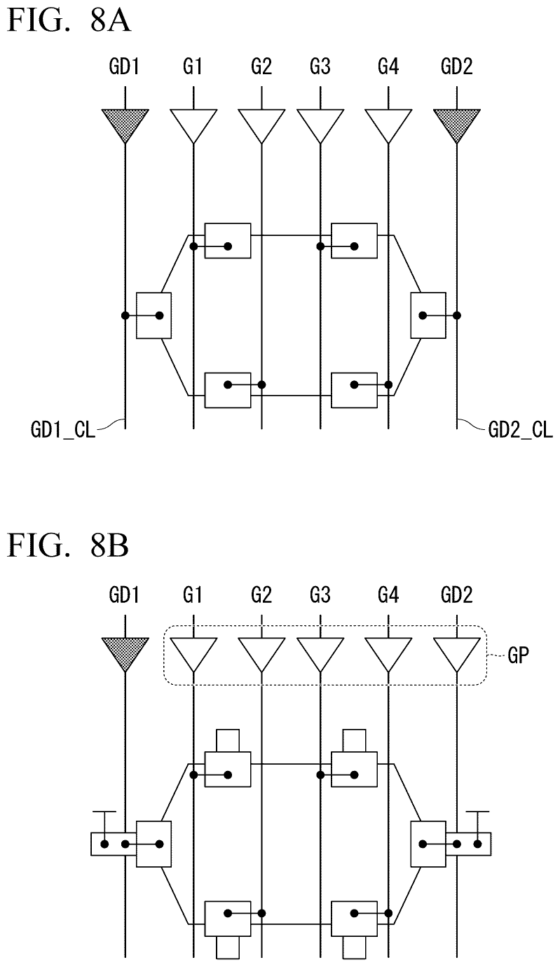

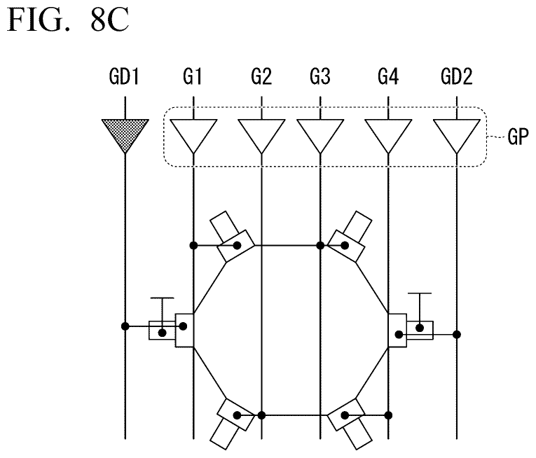

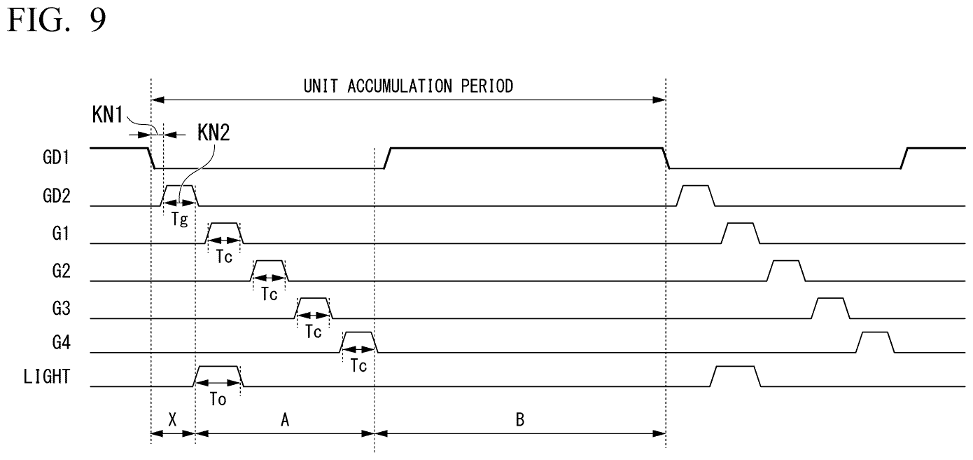

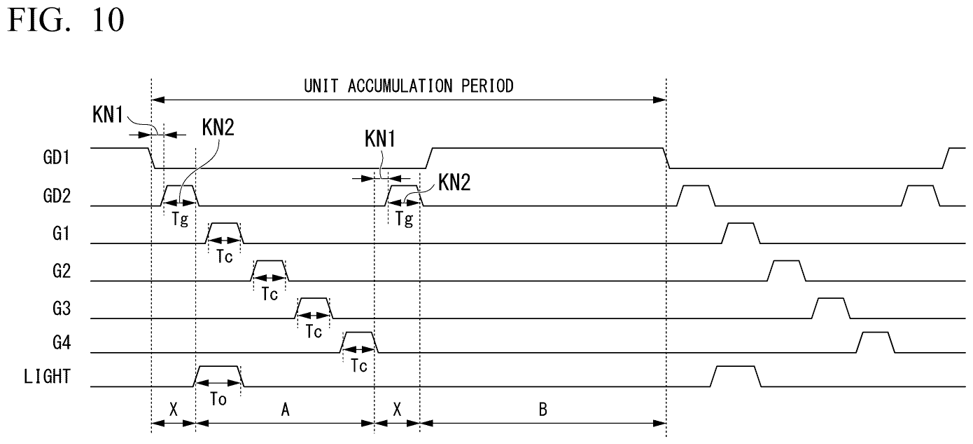

FIG. 8 (FIGS. 8A to 8C) is a diagram showing a layout example of the pixel 321 according to the embodiment. FIGS. 9 to 13 are timing charts showing driving examples of the pixel 321 according to the embodiment.

Each of the items of “GD”, “0 fixed”, “G1” to “G4”, and “LIGHT” in FIGS. 5 to 7 is the same as those in FIG. 4B, and thus the description thereof will be omitted.

FIG. 5 shows a driving example (first example) of the pixel 321 of the present embodiment. As shown in FIG. 5, in the present embodiment, the distance image capturing device 1 executes an adjustment phase X at the timing TG1 of FIG. 4B, that is, the timing at which the discharge phase B for the previously executed unit accumulation period is switched to the unit accumulation period to be executed this time.

In the adjustment phase X, the distance image capturing device 1 sequentially executes a first driving KN1 and a second driving KN2. In the first driving KN1, the charge discharge unit (charge discharge transistor GD) is caused not to discharge the charge, and the charge is not accumulated in the charge accumulation unit CS. In the second driving KN2, the charge is discharged through the charge discharge unit (charge discharge transistor GD).

Here, an execution time Tg for executing the second driving KN2 is the same time as the accumulation driving time Tc for executing the accumulation driving of accumulating the charge in one charge accumulation unit CS in the accumulation phase, that is, Tg=Tc.

As described above, in the present embodiment, the adjustment phase X is provided in the driving of the pixel 321 for the unit accumulation period. As a result, immediately before the charge accumulation unit CS1 accumulates the charge, the charge discharge unit (charge discharge transistor GD) is pulse-driven so that the accumulation of the charge in the charge accumulation unit CS1 is started at a timing at which the short-time charge accumulation in the charge accumulation unit in the previous stage is completed. Therefore, it is possible to make the driving conditions of the charge accumulation unit CS1, and the other charge accumulation units CS2 to CS4, which accumulate the charge second or subsequent times, close to each other, and it is possible to prevent deterioration in the accuracy of the distance.

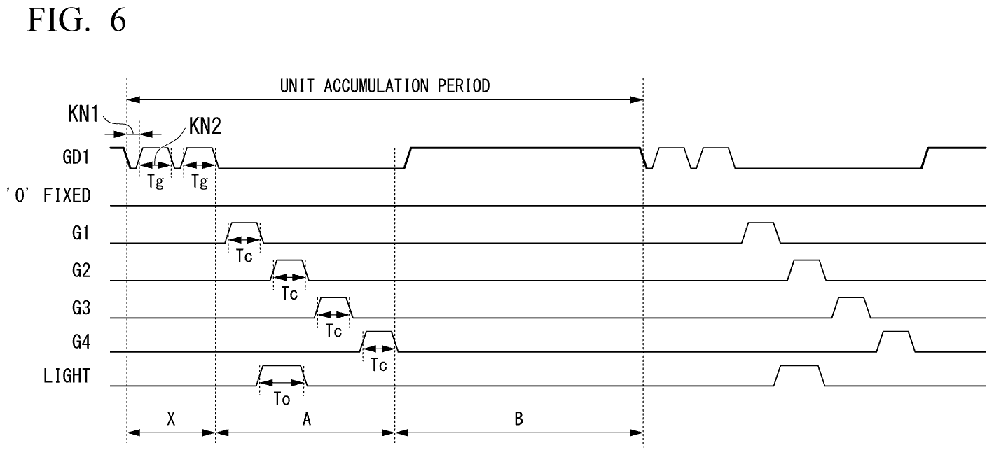

FIG. 6 shows a driving example (second example) of the pixel 321 of the present embodiment. As shown in FIG. 6, the distance image capturing device 1 may alternately execute the first driving KN1 and the second driving KN2 a plurality of times in the adjustment phase X.

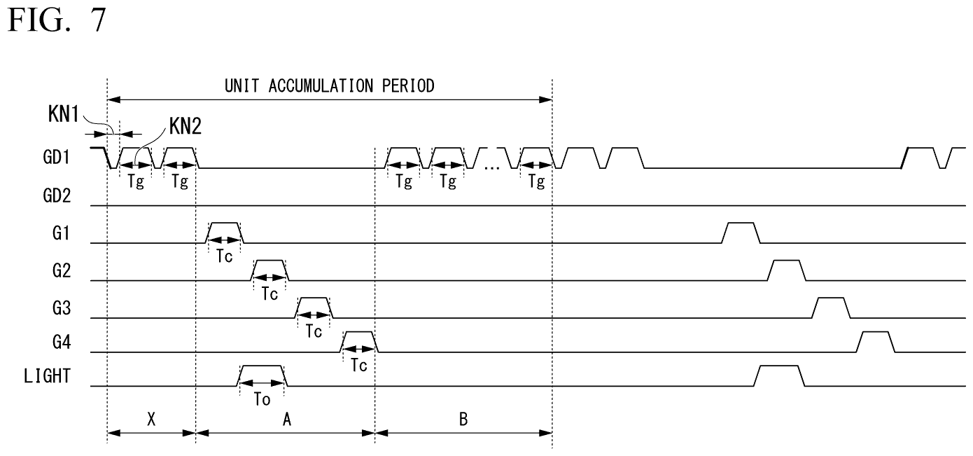

FIG. 7 shows a driving example (third example) of the pixel 321 of the present embodiment. As shown in FIG. 7, the distance image capturing device 1 may execute the driving of the adjustment phase X in the discharge phase B instead of maintaining the charge discharge transistor GD in the on state, that is, alternately execute the first driving KN1 and the second driving KN2.

FIG. 8A schematically shows a layout of the pixel 321 in which the charge discharge transistor GD2 of FIG. 4A functions as a charge discharge unit. In the example of this figure, the gate G of the charge discharge transistor GD1 is connected to a control signal GD1_CL for controlling the discharge of the charge. When the control signal GD1_CL is High (1), the charge is discharged, and when the control signal GD1_CL is Low (0 (zero)), the charge is not discharged.

In addition, the gate G of the charge discharge transistor GD2 is connected to a control signal GD2_CL for controlling the discharge of the charge. When the control signal GD2_CL is High (1), the charge is discharged, and when the control signal GD2_CL is Low (0 (zero)), the charge is not discharged.

By providing two charge discharge units (charge discharge transistors GD1 and GD2) in the pixel 321, the applications can be used separately. That is, the charge discharge unit (charge discharge transistor GD1) used for the purpose of discharging the charge for a long time and the charge discharge unit (charge discharge transistor GD2) used for the purpose of aligning the driving conditions of the charge accumulation unit CS1 and the other charge accumulation units CS2 to CS4 can be used separately. As a result, it is easy to make the driving conditions of the charge accumulation unit CS align while maintaining the function of discharging the charge.

FIG. 8B schematically shows a layout in which the buffer configurations of the control signals G1_CL to G4_CL and GD2_CL represented by the reference numeral GP are aligned in the pixel 321 of FIG. 8A. By aligning the buffer configurations, for example, by using the same power supply for the buffer power supply, the waveform (rising waveform and falling waveform) of the control signal of the charge discharge transistor GD2 can be set to the same waveform as the waveform (rising waveform and falling waveform) of the control signals of the transfer transistors G1 to G4. As a result, the electrical characteristics of the control waveform of the charge discharge unit (charge discharge transistor GD2) used for the purpose of aligning the driving conditions of the charge accumulation unit CS can be made closer to the electrical characteristics of the control waveform of the charge accumulation unit CS.

FIG. 8C schematically shows a layout in which the photoelectric conversion element PD is formed in a regular hexagonal shape. As described above, the buffer configurations of the control signals G1_CL to G4_CL and GD2_CL represented by the reference numeral GP are aligned, and the six gates G (gate G of the two charge discharge transistors GD and the four transfer transistors G1 to G4) included in the pixel 321 are symmetrically disposed to be point-symmetric with respect to the center of the regular hexagon. As a result, the load applied to each gate can be made equal, and the electrical characteristics of each control waveform can be made close to each other.

FIGS. 9 and 10 show a driving example in which two charge discharge units (charge discharge transistors GD1 and GD2) as shown in FIG. 8 are used.

FIG. 9 shows a driving example (fourth example) of the pixel 321 of the present embodiment. In the adjustment phase X, the distance image capturing device 1 discharges the charge by the charge discharge unit (charge discharge transistor GD1) used for the purpose of discharging the charge, and the charge discharge unit (charge discharge transistor GD2) used for the purpose of aligning the driving conditions sequentially executes the first driving KN1 and the second driving KN2.

FIG. 10 shows a driving example (fifth example) of the pixel 321 of the present embodiment. The distance image capturing device 1 executes the adjustment phase X at a timing at which the discharge phase B for the previously executed unit accumulation period is switched to the unit accumulation period to be executed this time, and executes the adjustment phase X at a timing at which the accumulation phase A ends.

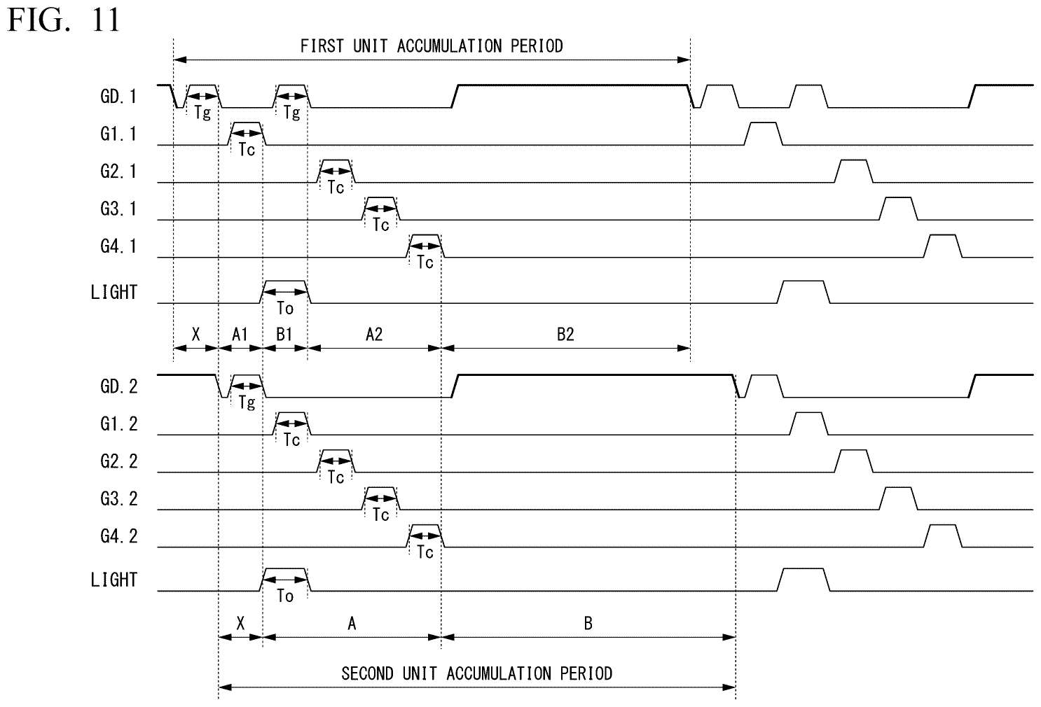

FIGS. 11 to 13 show a driving example in which one frame includes a plurality of sub-frames. Here, a case where two sub-frames, that is, a first sub-frame and a second sub-frame are provided in one frame will be described as an example. In addition, FIGS. 11 to 13 show a driving example in which one charge discharge unit is used similar to the driving shown in FIG. 4A.

FIGS. 11 to 13 show a timing chart of elements corresponding to each of the items of “GD. 1”, “G1. 1” to “G4. 1”, “GD. 2”, “G1. 2” to “G4. 2”, and “LIGHT”. The term “GD. 1” shows an operation timing of the control signal GD_CL for controlling the charge discharge transistor GD1 of the first sub-frame. The terms “G1. 1” to “G4. 1” show operation timings of control signals G1_CL to G4_CL for controlling the transfer transistors G1 to G4 of the first sub-frame. The term “GD. 2” shows an operation timing of the control signal GD_CL for controlling the charge discharge transistor GD1 of the second sub-frame. The terms “G1. 2” to “G4. 2” show operation timings of control signals G1_CL to G4_CL for controlling the transfer transistors G1 to G4 of the second sub-frame. The term “LIGHT” shows an irradiation timing of the optical pulse PO. The irradiation timing of the optical pulse PO is common in the first sub-frame and the second sub-frame.

In FIGS. 11 to 13, the distance image capturing device 1 first repeatedly executes the driving for the first unit accumulation period a predetermined number of times (first number of accumulation times) as the driving of the first sub-frame, and acquires the pixel signals Q1 to Q4 as the driving result of the first sub-frame to store the pixel signals in the memory. Next, the driving for the second unit accumulation period is repeatedly executed a predetermined number of times (second number of times of accumulation) as the driving of the second sub-frame, and the pixel signals Q1 to Q4 are acquired and stored in the memory as the driving result of the second sub-frame. The distance image capturing device 1 calculates the distance using the pixel signals Q1 to Q4 which are the driving results of the first sub-frame stored in the memory and the pixel signals Q1 to Q4 as the driving results of the second sub-frame.

FIG. 11 shows a driving example (sixth example) of the pixel 321 of the present embodiment. In FIG. 11, the distance image capturing device 1 executes the first accumulation phase Al, the first discharge phase B1, the second accumulation phase A2, and the second discharge phase B2 in this order after executing the adjustment phase X in the first unit accumulation period. In addition, the distance image capturing device 1 does not provide a charge accumulation unit dedicated to external light for the second unit accumulation period, executes the accumulation phase A at the same timing as the timing at which the first discharge phase B1 for the first unit accumulation period is executed, and then executes the discharge phase B.

In the first unit accumulation period, the charge accumulation unit CS1 is used as a charge accumulation unit dedicated to external light which accumulates only the external light components. The reason why the first discharge phase B1 is provided in the first unit accumulation period is to delay the accumulation timing for accumulating the charge in each of the charge accumulation units CS2 to CS4 with respect to the irradiation timing of the optical pulse PO, compared to the driving as shown in FIG. 5. By delaying the accumulation timing, a component of the reflected light RL that is reflected by the subject OB at a relatively long distance and then arrives is accumulated in any of the charge accumulation units CS2 to CS4.

In the second unit accumulation period, the charge accumulation unit CS1 is used as a charge accumulation unit that accumulates a component of the reflected light RL that is reflected by the subject OB at a short distance and then arrives. For each of the charge accumulation units CS2 to CS4, similar to the first unit accumulation period, a component of the reflected light RL that is reflected by the subject OB at a relatively long distance and then arrives is accumulated.

In general, the reflected light RL that is reflected by the subject OB at a short distance and then arrives has a large amount of light, and the reflected light RL that is reflected by the subject OB at a long distance and then arrives has a small amount of light. By performing the driving shown in FIG. 11, the number of times of accumulation of the component of the reflected light RL that is reflected by the subject OB at a short distance and then arrives can be reduced, and the number of times of accumulation of the component of the reflected light RL that is reflected by the subject OB at a long distance and then arrives can be increased. By reducing the number of times of accumulation of the component of the reflected light RL that is reflected by the subject OB at a short distance and then arrives, it is possible to prevent a situation in which the amount of charges to be accumulated in the charge accumulation unit CS is saturated and the distance cannot be calculated with high accuracy. By increasing the number of times of accumulation of the component of the reflected light RL that is reflected by the subject OB at the long distance and then arrives, it is possible to accumulate the amount of charges in the charge accumulation unit CS to the extent that the distance can be calculated with high accuracy.

Specifically, the distance image capturing device 1 sequentially executes the first driving KN1 and the second driving KN2 in the adjustment phase X for the first unit accumulation period. In the first accumulation phase A1, the charge accumulation unit CS accumulates the charge of the external light component by executing the accumulation driving of accumulating the charge in the charge accumulation unit CSI for the accumulation driving time Tc. In the first discharge phase B1, the distance image capturing device 1 discharges the charge through the charge accumulation unit (charge discharge transistor GD). In the second accumulation phase A2, the distance image capturing device 1 sequentially executes accumulation driving of accumulating the charge in each of the charge accumulation units CS2 to CS4 for the accumulation driving time Tc. In the second discharge phase B2, the distance image capturing device 1 discharges the charge through the charge accumulation unit (charge discharge transistor GD).

In addition, the distance image capturing device 1 sequentially executes the first driving KN1 and the second driving KN2 in the adjustment phase X for the second unit accumulation period. In the accumulation phase A, the distance image capturing device 1 sequentially executes accumulation driving of accumulating the charge in each of the charge accumulation units CS1 to CS4 for the accumulation driving time Tc. In the discharge phase B, the distance image capturing device 1 discharges the charge through the charge accumulation unit (charge discharge transistor GD).

As described above, in each of the plurality of sub-frames provided in one frame, the distance image capturing device 1 executes the adjustment phase X at a timing at which the discharge phase B for the previously executed unit accumulation period is switched to the unit accumulation period to be executed this time. As a result, by providing the adjustment phase X each of before the charge accumulation unit CS1 accumulates the charge in the first accumulation phase A1 for the first unit accumulation period, and before the charge accumulation unit CS1 accumulates the charge in the accumulation phase A for the second unit accumulation period, it is possible to make the driving and the driving conditions of the other charge accumulation units CS2 to CS4 close to each other.

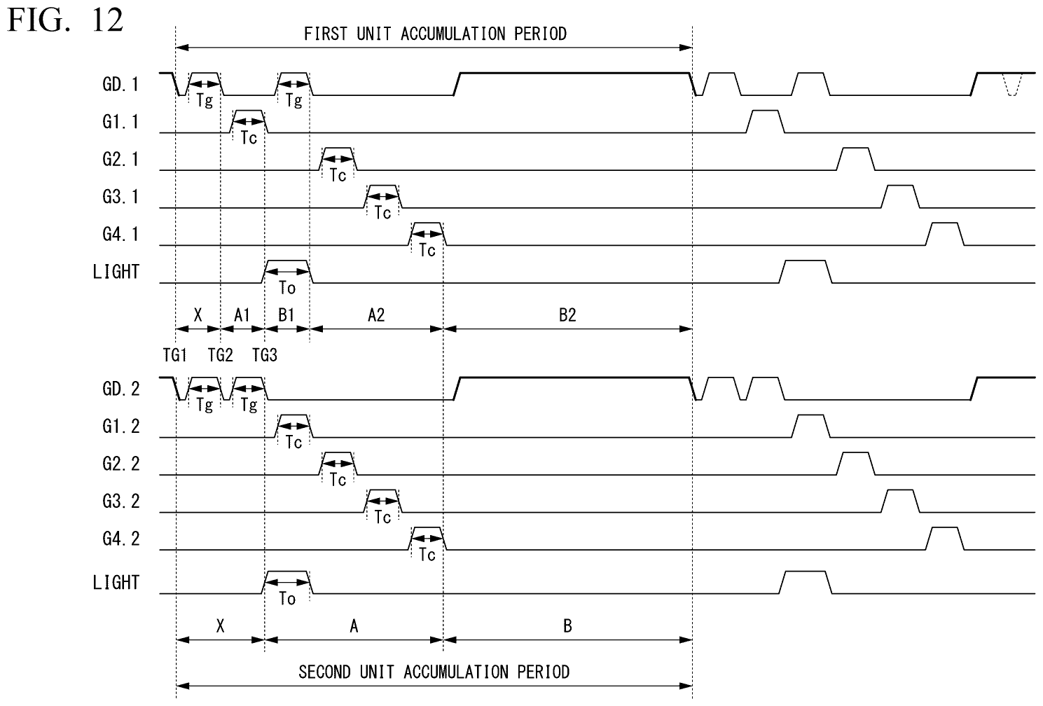

FIG. 12 shows a driving example (seventh example) of the pixel 321 of the present embodiment. Each of the first accumulation phase A1, the first discharge phase B1, the second accumulation phase A2, and the second discharge phase B2 in the first unit accumulation period, and the accumulation phase A and the discharge phase B in the second unit accumulation period shown in FIG. 12 is the same as each of those in FIG. 11.

As shown in FIG. 12, the distance image capturing device 1 may start the execution of the adjustment phase X for the second unit accumulation period at the same timing as the adjustment phase X for the first unit accumulation period, and may execute the adjustment phase X for the second unit accumulation period for a longer time than the adjustment phase X for the first unit accumulation period. In this case, the distance image capturing device 1 alternately executes the first driving KN1 and the second driving KN2 a plurality of times in the adjustment phase X for the second unit accumulation period.

Specifically, in the example of FIG. 12, the adjustment phase X for the first unit accumulation period is started at the timing TG1. In addition, the first accumulation phase A1 in the first unit accumulation period is started at the timing TG2. The accumulation phase A in the second unit accumulation period is started at the timing TG3. The timing TG2 arrives earlier than the timing TG3.

In a case where the elapsed time from the timing TG1 to the timing TG3 (that is, the time for executing the adjustment phase X in the second unit accumulation period) is longer than the time for executing the first driving KN1 and the second driving KN2 (once each), the distance image capturing device 1 may alternately execute the first driving KN1 and the second driving KN2 a plurality of times in the adjustment phase X for the second unit accumulation period.

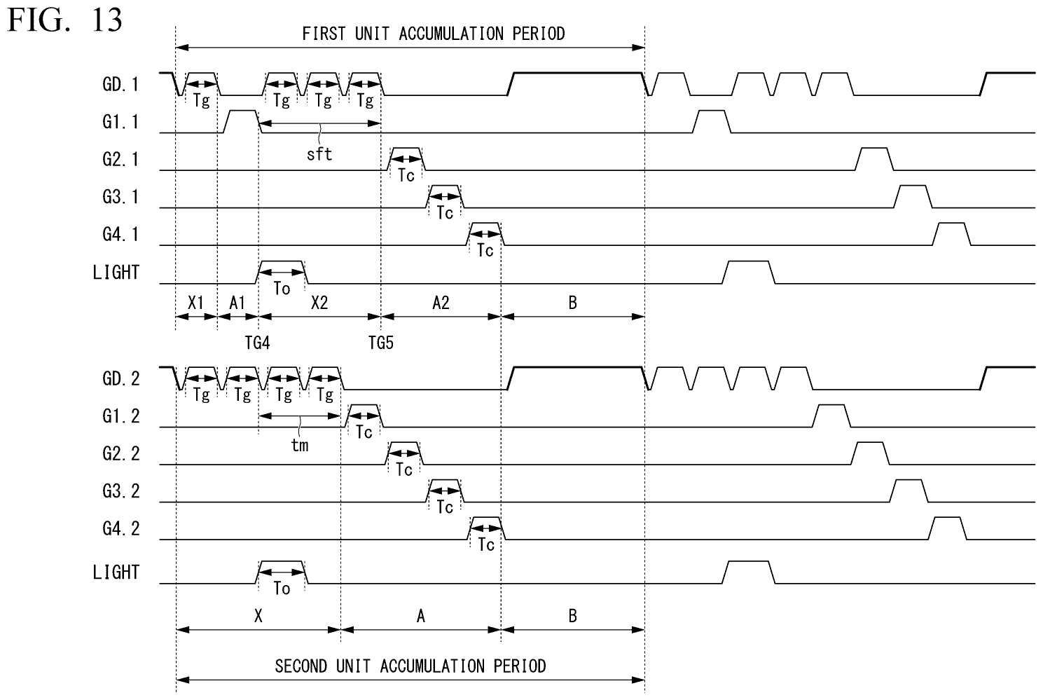

FIG. 13 shows a driving example (eighth example) of the pixel 321 of the present embodiment. In the driving example of FIG. 13, the component of the reflected light RL that is reflected by the subject OB at a farther distance than in the driving shown in FIGS. 11 and 12 and then arrives is accumulated in the pixel 321. Specifically, in the first unit accumulation period, a range shift period sft is provided between the irradiation timing and an accumulation timing at which the charge is accumulated in the charge accumulation unit CS2. In the second unit accumulation period, a linking period tm is provided from the irradiation timing to an accumulation timing at which the charge is accumulated in the charge accumulation unit CS1 in conjunction with the driving of a first unit accumulation section.

In a case where such a range shift period sft is provided, the distance image capturing device 1 may alternately execute the first driving KN1 and the second driving KN2 a plurality of times in the range shift period sft.

Specifically, in the example of FIG. 13, the charge accumulation in the charge accumulation unit CS1 in the first unit accumulation period ends at the timing TG4, and the charge accumulation in the next charge accumulation unit CS2 starts from the timing TG5.

In a case where the elapsed time from the timing TG4 to the timing TG5 (that is, the time for executing the adjustment phase X2 in the first unit accumulation period) is longer than the time for executing the first driving KN1 and the second driving KN2 (once each), the distance image capturing device 1 may alternately execute the first driving KN1 and the second driving KN2 a plurality of times in the adjustment phase X for the second unit accumulation period.

In a case where the range shift period sft is provided in the driving of the frame cycle in which the sub-frame is not provided, the distance image capturing device 1 may execute the adjustment phase X for the range shift period. For example, it is assumed that the range shift period sft between the timings TG4 and TG5 in the accumulation phase for the unit accumulation period in the frame cycle is provide in the distance image capturing device 1. In this case, in the accumulation phase for the unit accumulation period, the distance image capturing device 1 ends the charge accumulation in the charge accumulation unit CS1 at the timing TG4 and starts the charge accumulation in the next charge accumulation unit CS2 at the timing TG5. Since the elapsed time from the timing TG4 to the timing TG5 is longer than the time for executing the first driving KN1 and the second driving KN2 once, the distance image capturing device 1 alternately executes the first driving KN1 and the second driving KN2 a plurality of times in the elapsed time.

As described above, the distance image capturing device 1 according to the embodiment includes the light source unit 2, the light receiving unit 3, and the distance image processing unit 4. The light source unit 2 irradiates the subject OB with the optical pulse PO. The light receiving unit 3 includes the distance image sensor 32 (pixel circuit) in which the plurality of pixels 321, each having the photoelectric conversion element PD and three or more charge accumulation units CS, are arranged in a two-dimensional matrix shape, and the pixel drive circuit 322. The photoelectric conversion element PD generates the charge according to incident light. The charge accumulation unit CS accumulates the charge. The pixel drive circuit 322 distributes and accumulates the charges to each of the charge accumulation units CS at an accumulation timing synchronized with the irradiation timing at which the optical pulse PO is emitted according to the frame cycle. The distance image processing unit 4 calculates the distance to the subject OB based on the amount of charges accumulated in each of the charge accumulation units CS. The distance image capturing device 1 executes the driving for the unit accumulation period the number of accumulation times in the frame cycle. The distance image capturing device 1 executes the accumulation phase A and the discharge phase B in the unit accumulation period, and executes the adjustment phase X at a timing at which the previously executed discharge phase B of the unit accumulation period is switched to the unit accumulation period to be executed this time. In the accumulation phase A, the charge is sequentially accumulated in the charge accumulation unit CS at the accumulation timing synchronized with the irradiation timing. In the discharge phase B, the charge is discharged through the charge discharge unit. In the adjustment phase X, the distance image capturing device 1 sequentially executes a first driving KN1 and a second driving KN2. In the first driving KN1, the charge discharge unit is caused not to discharge the charge, and the charge is not accumulated in the charge accumulation unit. In the second driving KN2, the charge is discharged through the charge discharge unit. The time Tg for executing the second driving KN2 is the same as the accumulation driving time Tc for executing the accumulation driving of accumulating the charge in one charge accumulation unit CS in the accumulation phase A.

As a result, in the distance image capturing device 1 according to the embodiment, the pixel can be driven such that a difference is tempered in the driving conditions between the first charge accumulation unit which first accumulates the charge, and the other charge accumulation units which accumulate the charge second or subsequent times, among the plurality of charge accumulation units.

In addition, in the distance image capturing device 1 according to the embodiment, as shown in FIG. 6, the first driving KN1 and the second driving KN2 may be executed a plurality of times in the adjustment phase X. As a result, the same effect as the above-described effect can be obtained.

In addition, in the distance image capturing device 1 according to the embodiment, as shown in FIG. 7, in the discharge phase B, the first driving KN1 and the second driving KN2 in the adjustment phase X may be alternately executed. As a result, in the distance image capturing device 1 according to the embodiment, the same effect as the above-described effect can be obtained.

In addition, in the distance image capturing device 1 according to the embodiment, the charge discharge unit includes two charge discharge units, that is, the first charge discharge unit (charge discharge transistor GD1) and the second charge discharge unit (charge discharge transistor GD2). As shown in FIGS. 9 and 10, in the distance image capturing device 1, in the adjustment phase X, the first charge discharge unit (charge discharge transistor GD1) may discharge the charge, and the second charge discharge unit (charge discharge transistor GD2) may sequentially execute the first driving KN1 and the second driving KN2. As a result, it is easy to make the driving conditions of the charge accumulation unit CS align while maintaining the function of discharging the charge.

In addition, in the distance image capturing device 1 according to the embodiment, as shown in FIG. 10, the discharge phase B may be executed after the adjustment phase X is executed at a timing at which the accumulation phase A ends. As a result, all the driving conditions of the charge accumulation units CSI to CS4 can be made closer to each other.

In addition, in the distance image capturing device 1 according to the embodiment, as shown in FIGS. 11 to 13, a plurality of sub-frames may be provided in the frame cycle, and the pixel 321 may be driven such that the accumulation timing with respect to the irradiation timing is different from each other in each of the plurality of sub-frames. In each of the plurality of sub-frames, the distance image capturing device 1 executes the adjustment phase X at a timing at which the discharge phase B for the previously executed unit accumulation period is switched to the unit accumulation period to be executed this time. As a result, in the distance image capturing device 1 according to the embodiment, in the driving of the sub-frame, the driving condition of the charge accumulation unit CS1 can be made close to the driving conditions of the other charge accumulation units CS2 to CS4.

In addition, in the distance image capturing device 1 according to the embodiment, as shown in FIGS. 11 to 13, in a case where two sub-frames are provided in the frame, the adjustment phase X may be executed at the same timing TG1 (first timing) with respect to the irradiation timing of the optical pulse PO in the first sub-frame and the second sub-frame. The distance image capturing device 1 executes the adjustment phase X at the timing TG1 in the first sub-frame, executes the first accumulation phase A1 at the timing TG2 (second timing), and executes the accumulation phase at the timing TG3 (third timing) in the second sub-frame. The timing TG2 arrives earlier than the timing TG3.

In the second unit accumulation period of the second sub-frame, the distance image capturing device 1 starts the execution of the adjustment phase X at the timing TG1 and alternately executes the first driving KN1 and the second driving KN2 in the elapsed time, in a case where the elapsed time from the timing TG2 to the timing TG3 is longer than the time for executing each of the first driving KN1 and the second driving TN2 (once each).

As a result, in the distance image capturing device 1 according to the embodiment, in the driving for the frame cycle including the sub-frame, the driving condition of the charge accumulation unit CS1 can be made close to the driving conditions of the other charge accumulation units CS2 to CS4.

In addition, in the distance image capturing device 1 according to the embodiment, as shown in FIG. 13, in a case where the range shift period sft is provided, the adjustment phase X may be executed instead of the discharge phase B in the range shift period sft. The distance image capturing device 1 ends the charge accumulation in the charge accumulation unit CS1 at the timing TG4 (fourth timing) in the accumulation phase A, and starts the charge accumulation in the charge accumulation unit CS2 that accumulates the charge next to the charge accumulation unit CS1 at the timing TG5 (fifth timing). The elapsed time from the timing TG4 to the timing TG5 is longer than the time for executing each of the first driving KN1 and the second driving KN2. The distance image capturing device 1 alternately executes the first driving KN1 and the second driving KN2 in the elapsed time. As a result, in the distance image capturing device 1 according to the embodiment, in the driving including the range shift period, the driving condition of each of the charge accumulation units CS1 to CS4 can be made close to each other.

All or a part of the distance image capturing device 1 and the distance image processing unit 4 in the above-described embodiment may be implemented by a computer. In this case, a program for implementing the functions may be recorded on a computer-readable recording medium, and a computer system may read and execute the program recorded on the recording medium to implement the functions. The term “computer system” here includes an OS and hardware such as a peripheral device. In addition, the term “computer-readable recording medium” refers to a portable medium such as a flexible disk, a magneto-optical disk, a ROM, or a CD-ROM, and a storage device such as a hard disk built into a computer system. Furthermore, the term “computer-readable recording medium” may include a medium that dynamically holds the program for a short period, such as a communication line for transmitting the program via networks such as the Internet and communication lines such as telephone lines, and a medium that holds a program for a certain period, such as a volatile memory inside a computer system that is a server or a client in that case. In addition, the program may be configured to implement a part of the above-described function, may be configured to implement the above-described function by combination with the program recorded in advance in a computer system, or may be configured to implement the program by using a programmable logic device such as FPGA.

Although preferred embodiments of the present disclosure have been described and shown, it is to be understood that these embodiments are exemplary of the present disclosure and are not considered as restrictions. Additions, omissions, substitutions, and other changes can be made without departing from the scope of the present invention. Accordingly, the present invention should not be considered as being limited by the foregoing description, and is only limited by the scope of the appended claims.

What is claimed is:

1. A distance image capturing device comprising:
a light source unit configured to irradiate a subject with an optical pulse;
a light receiving unit including a distance image sensor in which a plurality of pixels having a photoelectric conversion element configured to generate a charge in accordance with incident light, a charge discharge unit configured to discharge the charge generated by the photoelectric conversion element, and a plurality of charge accumulation units configured to accumulate the charge generated by the photoelectric conversion element are arranged in a two-dimensional matrix shape, and a pixel drive circuit configured to distribute and accumulate the charge to each of the charge accumulation units at an accumulation timing synchronized with an irradiation timing at which the optical pulse is emitted according to a frame cycle; and
a distance image processing unit configured to calculate a distance to the subject based on an amount of charges accumulated in each of the charge accumulation units, wherein
a driving for a unit accumulation period is executed the number of accumulation times in the frame cycle,
in the unit accumulation period, an accumulation phase in which the charge is sequentially accumulated in the charge accumulation unit at the accumulation timing, and a discharge phase in which the charge is discharged through the charge discharge unit are executed, and an adjustment phase is executed at a timing at which the discharge phase for a previously executed unit accumulation period is switched to the unit accumulation period to be executed this time,
in the adjustment phase, a first driving in which the charge discharge unit is caused not to discharge the charge and the charge is not accumulated in the charge accumulation unit, and a second driving in which the charge is discharged through the charge discharge unit are sequentially executed, and
a time for executing the second driving is the same as an accumulation driving time for executing an accumulation driving in which the charge is accumulated in one charge accumulation unit in the accumulation phase.

2. The distance image capturing device according to claim 1, wherein
the first driving and the second driving are executed a plurality of times in the adjustment phase.

3. The distance image capturing device according to claim 1, wherein
in the discharge phase, the first driving and the second driving in the adjustment phase are alternately executed.

4. The distance image capturing device according to claim 1, wherein
the charge discharge unit includes two units of a first charge discharge unit and a second charge discharge unit, and
in the adjustment phase, the first charge discharge unit discharges the charge and the second charge discharge unit sequentially executes the first driving and the second driving.

5. The distance image capturing device according to claim 4, wherein
the discharge phase is executed after the adjustment phase is executed at a timing at which the accumulation phase ends.

6. The distance image capturing device according to claim 1, wherein
a plurality of sub-frames are provided in the frame cycle,
in each of the plurality of sub-frames, the accumulation timing with respect to the irradiation timing is different from each other, and
in each of the plurality of sub-frames, the adjustment phase is executed at the timing at which the discharge phase for the previously executed unit accumulation period is switched to the unit accumulation period to be executed this time.

7. The distance image capturing device according to claim 1, wherein
two sub-frames of a first sub-frame and a second sub-frame are provided in the frame cycle,
in the first sub-frame, the adjustment phase is executed at a first timing at which the discharge phase for the previously executed unit accumulation period is switched to the unit accumulation period to be executed this time, and the accumulation phase is executed at a second timing based on the irradiation timing,
in the second sub-frame, the accumulation phase is executed at a third timing based on the irradiation timing,
the second timing arrives earlier than the third timing,
in the second sub-frame, an execution of the adjustment phase starts at the first timing,
an elapsed time until the third timing is reached from the second timing is longer than a time for executing each of the first driving and the second driving, and
the first driving and the second driving are alternately executed in the elapsed time.

8. The distance image capturing device according to claim 1, wherein,
in the accumulation phase, a charge accumulation in a first charge accumulation unit among the charge accumulation units ends at a fourth timing, and a charge accumulation in a second charge accumulation unit that accumulates the charge next to the first charge accumulation unit starts at a fifth timing,
an elapsed time until the fifth timing is reached from the fourth timing is longer than a time for executing each of the first driving and the second driving, and
the first driving and the second driving are alternately executed in the elapsed time.

9. A distance image capturing method performed by a distance image capturing device including a light source unit configured to irradiate a subject with an optical pulse, a light receiving unit including a distance image sensor in which a plurality of pixels having a photoelectric conversion element configured to generate a charge in accordance with incident light, a charge discharge unit configured to discharge the charge generated by the photoelectric conversion element, and a plurality of charge accumulation units configured to accumulate the charge generated by the photoelectric conversion element are arranged in a two-dimensional matrix shape, and a pixel drive circuit configured to distribute and accumulate the charge to each of the charge accumulation units at an accumulation timing synchronized with an irradiation timing at which the optical pulse is emitted according to a frame cycle, and a distance image processing unit configured to calculate a distance to the subject based on an amount of charges accumulated in each of the charge accumulation units, the method comprising:
executing a driving for a unit accumulation period the number of accumulation times in the frame cycle;
executing, in the unit accumulation period, an accumulation phase in which the charge is sequentially accumulated in the charge accumulation unit at the accumulation timing, and a discharge phase in which the charge is discharged through the charge discharge unit, and executing an adjustment phase at a timing at which the discharge phase for a previously executed unit accumulation period is switched to the unit accumulation period to be executed this time; and
sequentially executing, in the adjustment phase, a first driving in which the charge discharge unit is caused not to discharge the charge and the charge is not accumulated in the charge accumulation unit, and a second driving in which the charge is discharged through the charge discharge unit, wherein
a time for executing the second driving is the same as an accumulation driving time for executing an accumulation driving in which the charge is accumulated in one charge accumulation unit in the accumulation phase.
